(19) United States
(12) Patent Application Publication
(10) Pub. No.: US 2026/0350390 A1
(43) Pub. Date: Nov. 5, 2026

(54) ADVERSARIAL ACCELERATION OF RECTIFIED FLOWS

(71) Applicant: Stability AI Ltd, London (GB)

(72) Inventors: Zachary Novack, San Diego, CA (US); Zach Evans, Bellevue, WA (US); Zachary Zukowski, Sacramento, CA (US); Josiah Taylor, Stafford (GB); Julian Parker, London (GB); Jordi Pons, Sabadell (ES); CJ CARR, Medford, MA (US)

(73) Assignee: Stability AI Ltd, London (GB)

(21) Appl. No.: 19/666,109

(22) Filed: May 1, 2026

Related U.S. Application Data
(60) Provisional application No. 63/800,185, filed on May 5, 2025.

(30) Foreign Application Priority Data
May 2, 2025 (EP) EP25382449.4

(51) Int. Cl. G06N 3/08; G06F 18/214; G06F 18/22; G06N 3/0475

(52) U.S. Cl. CPC G06N 3/08; G06F 18/214; G06F 18/22; G06N 3/0475

(57) ABSTRACT

Techniques include obtaining ground truth training data including first content, wherein the ground truth training data includes a first latent space representation of the first content. Techniques further include generating, based at least in part on inputting the noisy training data to a generative model, de-noised training data. Techniques further include generating, based at least in part on inputting the de-noised training data to a discriminator model, a first score. Techniques further include adjusting a parameter of the discriminator model based at least in part on the first score. Techniques further include adjusting a second parameter of a generative model based at least in part on the first score.

### CROSS REFERENCE TO RELATED APPLICATIONS

This application claims the benefit of and priority to U.S. Provisional Application No. 63/800,185, filed May 5, 2025, and titled “Adversarial Acceleration of Rectified Flows,” the content of which is herein incorporated by reference in its entirety for all purposes. This application also incorporates by reference for all purposes in its entirety paper publication “Fast Text-to-Audio Generation with Adversarial Post-Training” to Novack et al., arXiv:2505.08175v3 [cs.SD] 20 May 2025.

### BACKGROUND

Artificial intelligence models (e.g., generative artificial intelligence models) have gained mainstream attention recently for their capabilities. Despite the impressive progress that has been made in the field of machine learning, existing techniques for training artificial intelligence models and use cases of artificial intelligence models could be further improved.

### BRIEF DESCRIPTION OF THE DRAWINGS

Features, embodiments, and advantages of the present disclosure are better understood when the following Detailed Description is read with reference to the accompanying drawings.

FIG. 1 is a block diagram illustrating an example adversarial asset generation system, according to certain embodiments.

FIG. 2 is a block diagram illustrating an example adversarial asset generation system during training, according to certain embodiments.

FIG. 3 is a block diagram illustrating an example generative model system during training, according to certain embodiments.

FIG. 4 is a block diagram illustrating an example discriminator model system during training, according to certain embodiments.

FIG. 5 is a block diagram illustrating an example method of using an adversarial asset generation system, according to certain embodiments.

FIG. 6 is a block diagram of an exemplary computer apparatus, according to certain embodiments.

### DETAILED DESCRIPTION

Certain embodiments describe techniques for generating high-fidelity digital assets or content from an input by producing latent space representations and/or synthesized assets or content such as acoustic waveforms, visual textures, or multi-dimensional data structures. This capability can provide significant utility across a range of applications and industries, including digital signal processing, professional audio production, procedural content generation for gaming, visualization, and the development of immersive environments in augmented reality (AR), virtual reality (VR), and mixed reality (MR).

The following techniques can address several challenges inherent in the training of generative models, particularly the issues of gradient saturation, semantic drift, and/or the loss of perceptual fidelity in synthesized high-dimensional assets.

In an adversarial framework, a generative model and a discriminator model can function as competing entities within a structured training loop designed to drive mutual optimization. The generative model can be configured to synthesize assets that attempt to emulate the statistical distributions and high-dimensional features of the target assets or content. The generative model’s primary objective can be to produce outputs that minimize the detectable discrepancy between synthetic samples and real-world targets. Conversely, the discriminator model may act as a rigorous evaluator, training itself to identify inconsistencies, artifacts, or semantic misalignments within the synthesized representations.

This adversarial tension creates a dynamic where the discriminator model can only improve by sharpening its ability to distinguish between authentic (i.e., target) and synthetic data, while the generative model can only improve by refining its output to satisfy the discriminator's increasingly stringent criteria. As the discriminator becomes more adept at recognizing nuances, it provides a more sophisticated feedback signal, which in turn necessitates that the generative model achieves a higher degree of perceptual fidelity and statistical authenticity in its outputs. Through this continuous cycle of competition and recursive refinement, the models can push one another toward a state of convergence, ultimately resulting in the production of digital assets or content that can be indistinguishable from the target state.

Furthermore, the techniques discussed can support a rigorous alignment between a user's conceptual and/or semantic intent and the resulting asset or content. Without a technique to measure the relative distance between synthetic distributions and ground truth targets, the generative model may produce outputs that are semantically inaccurate. The techniques herein can utilize the integration of a contrastive loss and a relativistic loss to establish a multidimensional gradient that enforces both semantic adherence to the user's intent and statistical alignment with the target asset data manifold.

### I. SYSTEM ARCHITECTURES

Systems described herein may include systems for training and using various models (e.g., a diffusion model, an encoder, etc.) and systems. The various models may be used to provide an adversarial asset generation system that can generate an output based on an input.

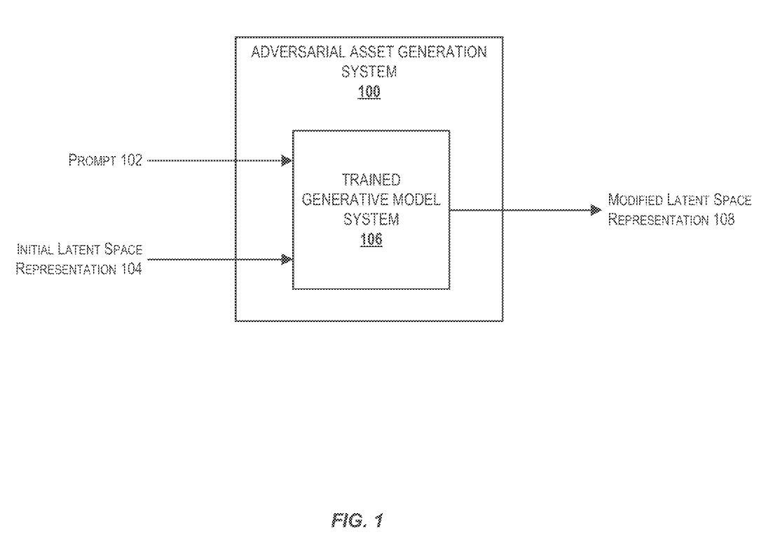

FIG. 1 is a block diagram illustrating an example adversarial asset generation system 100, according to certain embodiments. The adversarial asset generation system 100 may include a trained generative model system 106. The trained generative model system 106 may be trained in accordance with the techniques described herein. The trained generative model system 106 may be configured to generate a modified latent space representation 108 based on a prompt 102 and an initial latent space representation 104. The trained generative model system 106 may operate iteratively and may optionally receive a previously generated modified latent space representation 108, repeating the process to generate a further refined modified latent space representation 108. The trained generative model 106 may be initialized from a pretrained rectified model. In some embodiments, the trained generative model 106 may be initialized from a pretrained diffusion model.

The initial latent space representation 104 may refer to a data structure, such as feature embeddings or latent vectors, generated by the trained generative model system 106. Additionally, the initial latent space representation 104 may represent or encode content or an asset, such as an audio signal or a visual asset, such as an image or video. The initial latent space representation 104 may be received from a system separate from the trained generative model system 106, such as a noise generator, an external generative model, or a data storage repository.

The initial latent space representation 104 may include “pure noise,” as in isotropic Gaussian noise. In such embodiments, the trained generative model system 106 may receive a high-entropy data structure that lacks any discernible pattern or feature. For example, the initial latent space representation 104 may be generated by sampling a vector from a standard normal distribution where each element is independently and identically distributed, providing a stochastic "blank canvas."

Additionally or alternatively, the initial latent space representation 104 may include a pre-existing latent space representation associated with a specific content or asset, such as an encoded audio or visual sample. For example, the initial latent space representation 104 may include an embedding of the content associated with the prompt 102, such as an audio sample or visual asset. Additionally or alternatively, the initial latent space representation 104 may be generated based on content provided separately from the prompt 102. Additionally or alternatively, the initial latent space training representation 104 may be a latent representation derived from the prompt 102. For example, the adversarial asset generation system 100 may utilize an encoder or a pre-trained transformer to project the semantic content of the training prompt 102 into the same latent space as the target asset or content.

The initial latent space representation 104 can be generated to be a lower dimensional representation as compared to the decoded output. To illustrate, the initial latent space representation 104 may include a compressed feature embedding or vector that represents the underlying features of an audio signal or visual asset at a fraction of its raw data size (e.g., a 128-dimensional embedding, in certain embodiments). This reduced dimensionality can ensure that the trained generative model system 106 can perform computational optimization and data modulation with lower memory and latency requirements as compared to a system that requires backpropagating through a decoder or feature extraction operating in a high-dimensional audio signal or visual asset space.

The prompt 102 may be received from a user device, a user interface, a system external to the trained generative model system 106, and/or a data storage repository. In some embodiments, the prompt 102 may include natural language text and may specify a query or a request. Alternatively, or additionally, the prompt 102 may comprise machine-readable instructions.

In some embodiments, the prompt 102 can indicate or include specific content, such as an audio signal or a visual asset. The prompt 102 may indicate a feature associated with this content. The prompt 102 may include instructions to modify the feature associate with the content. For example, the prompt 102 may comprise a natural language request stating, “modify the pitch to be higher,” and further include an audio sample of a specific song. In this example, the content is the audio sample, and the feature indicated by the prompt 102 is the pitch. The prompt 102 includes instructions to increase the pitch of the audio sample. For a prompt 102 where the content is a visual asset, the prompt 102 may comprise a natural language request stating, “modify the lighting to be more dramatic.” In this example, the content is the visual asset, the feature indicated by the prompt 102 is the lighting, and the instructions are to dramatize the lighting. Other possible features can include audio intensity, beat of an audio sample, rhythmic pattern, timbre, texture, spatiality, reverb, vibrato, articulation, loudness, dynamics. Additional possible features can include luminance, lighting, composition, color palette, saturation, depth of field, proportions, geometric complexity, materiality, or symmetry.

In some embodiments, the prompt 102 can serve as a multi-modal control signal that defines one or more target characteristics for the adversarial asset generation system 100 to use in the generative process to steer toward the desired output. For instance, the prompt 102 may simultaneously provide a natural language description of a musical genre and a symbolic Musical Instrument Digital Interface (MIDI) file that dictates a specific melodic progression for the output to follow. Beyond natural language text, the prompt 102 may include content. The content may include structural metadata, such as symbolic musical notation (e.g., MIDI data), spectral envelopes, video content, three-dimensional content, or rhythmic patterns. A spectral envelope can be a curve that outlines the overall shape of an audio signal's spectrum by connecting the peaks of its frequency components, effectively representing the timbre or "color" of the sound. A rhythmic pattern can be a specific sequence of musical events, such as beats or notes, arranged in time to create a structured and recurring durational framework.

In some embodiments, the trained generative model system 106 may utilize an encoder to transform the prompt 102 into a high-dimensional embedding. The encoder may comprise a pre-trained transformer-based model, such as a CLIP (Contrastive Language-Image Pre-training) or T5 (Text-to-Text Transfer Transformer) encoder, which projects the user’s input into a continuous vector space.

The trained generative model system 106 may generate a modified latent space representation 108 at a first timestep based on the initial latent space representation 104 and the prompt 102. The trained generative model system 106 may generate a subsequent modified latent space representation 108 at a second timestep, where the subsequent modified latent space representation 108 may be based on the modified latent space representation 108 from the first timestep. The modified latent space representation 108 may refer to a state of the data that has been modified or adjusted to align with specific target features while remaining within the same latent space as the initial latent space representation 104. As an example, where the prompt 102 specifies a target musical chord, the modified latent space representation 108 may comprise a vector wherein specific latent dimensions associated with harmonic or spectral characteristics are modified toward a state that represents the target musical chord. Similarly, for visual assets, the modified latent space representation 108 may represent a specific lighting configuration if the prompt 102 specified a target lighting configuration.

In some embodiments, the trained generative model system 106 may also be configured to modify other types of assets or content, such as graphics, multi-dimensional models, animations, or other data structures, in response to prompts 102 specifying corresponding target features. For example, the trained generative model system 106 may adjust geometric, textural, or spatial attributes of a multi-dimensional model, or modify visual elements within graphics to achieve a desired feature state or functional outcome as indicated by the prompt 102.

It should be noted that the modified latent space representation 108 may refer to a modified state during any timestep of an iterative denoising loop executed by the trained generative model system 106. The modified latent space representation 108 may also refer to a final modified latent space representation 108 at the conclusion of the process executed by the adversarial asset generation system 100. Once the adversarial asset generation system 100 reaches the final timestep of the process, the final modified latent space representation 108 may be passed to a decoder (e.g., a Variational Autoencoder (VAE) decoder, a high-fidelity vocoder) to be transformed into a human-perceivable content or asset, such as a synthesized audio waveform or an image.

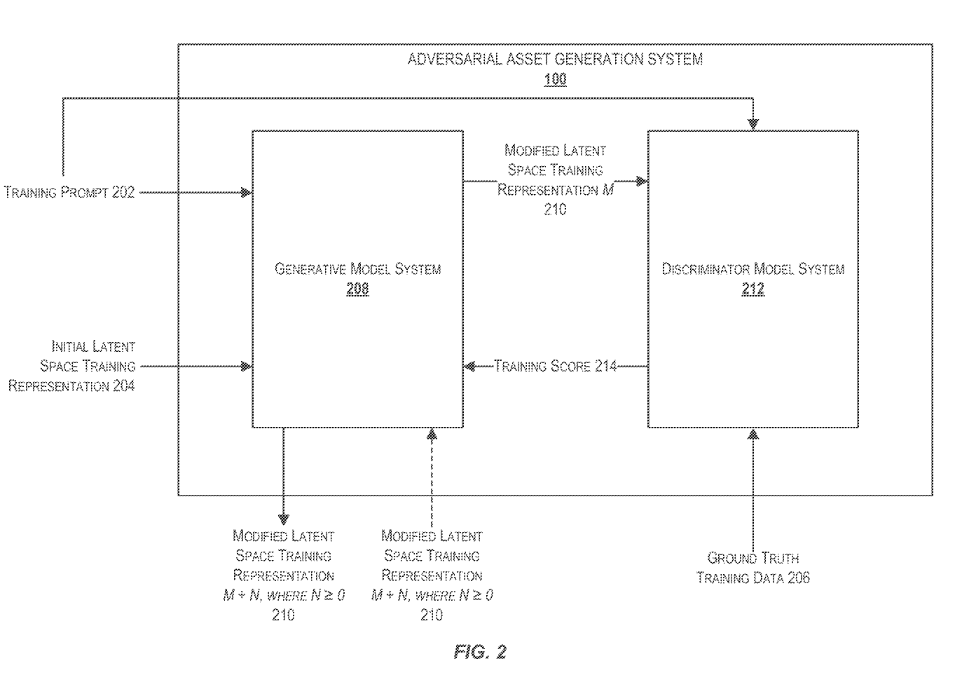

FIG. 2 is a block diagram illustrating an example adversarial asset generation system 100 (e.g., adversarial asset generation system 100 described above) during training, according to certain embodiments. The adversarial asset generation system 100 may be trained in accordance with an iterative process; as such, certain outputs generated during a first timestep may be utilized as inputs for a subsequent timestep. The subsequent timestep is not necessarily limited to being immediately consecutive to the first timestep.

An objective of the training process of the adversarial asset generation system 100 may be to generate a modified latent space training representation that is indistinguishable from corresponding ground truth training data. The adversarial asset generation system 100 may be, in some embodiments, trained to generate a trained generative model system 106 (e.g., trained generative model system 106 described above) that can generate a modified latent space representation 108 (e.g., modified latent space representation 108 described above) that minimizes the probability of a model successfully distinguishing between the generated modified latent space representation 108 and ground truth training data. Additionally or alternatively, the adversarial asset generation system 100 may be trained to generate a trained generative model system 106 that can generate modified latent space representations 108 that would be evaluated as being equally authentic to the ground truth, or that achieve a target score associated with authentic data if the modified latent space representations 108 were to be evaluated by a specially trained model.

In some embodiments, the generative model system 106 can be configured to generate modified latent space representations 108 that exhibit enhanced perceptual fidelity relative to the ground truth training data or the source-domain assets being emulated. This enhancement may include the attenuation or removal of stochastic artifacts (e.g., sensor noise, compression loss, etc.) present in the ground truth or the source-domain assets. Additionally or alternatively, this may include synthetic reconstruction of components absent from the ground truth or the source-domain assets. For example, the generative model system 106 may synthesize structural details or spectral textures that effectively increase the information density of the modified latent space representation 108 beyond that of the corresponding ground truth training data. As a result, the trained generative model system 106 may be trained to target an idealized version of what the asset or content should look like or sound like, rather than just copying the training data exactly. This can allow the adversarial asset generation system 100 to produce outputs that are actually clearer or higher quality than the original ground truth data used during the training process. In view of this context, the training process is now described in further detail herein.

For purposes of clarity, certain elements illustrated in FIG. 2 may be denoted by a timestep identifier to distinguish between recursive stages of the iterative training process. To minimize descriptive redundancy, the specific operations and data flows associated with a timestep M+N are not explicitly illustrated in every instance. However, it should be understood by one of ordinary skill in the art that the technical descriptions, transformations, and operations described with reference to an element at timestep M are equally applicable to corresponding elements at timestep M+N, where N is greater than or equal to 0.

The adversarial asset generation system 100 may include a generative model system 208 and/or a discriminator model system 212. The generative model system 208 and/or the discriminator model system 212 may be initialized from a pretrained rectified model. In some embodiments, the generative model system 208 and/or the discriminator model system 212 may be initialized from a pretrained diffusion model. The adversarial asset generation system 100 may receive a training prompt 202, an initial latent space training representation 204, ground truth training data 204. The adversarial asset generation system 100 may generate a modified latent space training representation 210. The adversarial asset generation system 100 may optionally receive a modified latent space training representation 210 generated at a given timestep.

The generative model system 208 may be configured to receive a training prompt 202 and/or an initial latent space training representation 204. Based on the training prompt 202 and/or the initial latent space training representation 204, the generative model system 208 may generate a modified latent space training representation 210 at a first timestep (e.g., timestep M).

At a subsequent timestep, the generative model system 208 may receive a training score 214 and/or a previously generated modified latent space training representation (e.g., representation M). The generative model system 208 may then generate a further refined modified latent space training representation 210 at timestep M+N (where N is greater than or equal to 0), based on the training prompt 202, the training score 214, and/or the modified latent space training representation 210 generated at a preceding timestep.

In some embodiments, the generative model system 208 may not receive the training score 214 as a direct data input or feature. Instead, the training score 214 may influence the generative model system 208 exclusively through the process of backpropagation during the training phase. In this configuration, a differentiable loss function can calculate the error between the modified latent space training representation 210 and the ground truth training data 206, and the resulting gradient can be propagated back through the network. This gradient can serve as a directional signal that updates the internal weights of the generative model system 208 to minimize the error in subsequent iterations. Consequently, the generative model system 208 can learn to produce more accurate modified latent space training representations 210 by adjusting its internal parameters in response to the mathematical pressure exerted by the gradient during optimization. The generative model system 208 can be responsible for the iterative synthesis and refinement of data within a lower-dimensional latent space. Functioning as the generator within the adversarial asset generation system 100, the generative model system 208 can be configured to transform high-entropy or initial states into structured, high-fidelity assets or content after being trained. By operating within a lower-dimensional latent space, the generative model system 208 can avoid the computational burden associated with processing raw high-dimensional data, thereby enabling complex optimizations with lower latency and memory overhead.

The training prompt 202 may include semantic data or metadata configured to condition the adversarial asset generation system 100 during the training phase. For example, the training prompt 202 may include a text-based description, a sequence of tokens, and/or a semantic embedding that characterizes a desired output, such as a specific audio signal or visual asset. In some embodiments, the training prompt 202 is provided to the generative model system 208 to guide the transformation of the initial latent space training representation 204 into the modified latent space training representation 210.

The initial latent space training representation 204 may include a lower-dimensional data structure configured to serve as the foundational input for the generative model system 208. In some embodiments, the initial latent space training representation 204 may comprise a vector, a tensor, or a compressed feature embedding that represents a condensed version of an asset or content (e.g., an audio signal or visual asset). In some embodiments, the initial latent space training representation 204 may consist of a distribution of random noise, such as Gaussian noise, which serves as a stochastic starting point for the training process.

Additionally or alternatively, the initial latent space training representation 204 may be a latent representation derived from the training prompt 202. In such embodiments, the adversarial asset generation system 100 may utilize an encoder or a pre-trained transformer to project the semantic content of the training prompt 202 into the same latent space as the target asset. By deriving the initial representation directly from the prompt, the system provides the generative model system 208 with a semantically-informed starting state, rather than a stochastic or random distribution. The initial latent space training representation 204 may be a latent representation derived from the training prompt 202. In such embodiments, the adversarial asset generation system 100 may utilize an encoder or a pre-trained transformer to project the semantic content of the training prompt 202 into the same latent space as the target asset or content (e.g., ground truth training data 206). By deriving the initial representation directly from the prompt, the system can provide the generative model system 208 with a semantically-informed starting state, rather than a stochastic or random distribution.

The generative model system may generate the modified latent space training representation 210 based on the training prompt 202 and the initial latent space training representation 204. The modified latent space training representation 210 may include a high-fidelity feature embedding that exists within the same lower-dimensional manifold as the initial latent space training representation 204. The modified latent space training representation 210 may be iteratively modulated by the generative model system 208 to encode structured semantic information derived from the training prompt 202.

During an initial iteration (e.g., timestep M), the generative model system 208 can be configured to establish a primary semantic mapping by transforming the initial latent space training representation 204 based on the conditioning provided by the training prompt 202. In this foundational stage, the generative model system 208 may utilize the semantic constraints of the training prompt 202 to define an initial trajectory within the latent space manifold. This initial trajectory can organize the high-entropy or unstructured data of the initial latent space representation 204 into a nascent feature set (e.g., modified latent space training representation 210 at timestep M). In the absence of a preceding training score 214, this modified latent space training representation 210 can represent a directed mapping of prompt-to-latent features. This initial version may be subsequently provided to the discriminator model system 212 to elicit the first training score 214, thereby enabling the recursive, score-guided modulation described in subsequent timesteps (e.g., timestep M+N), as described in greater detail herein.

The modified latent space training representation 210 can serve as a compact, computationally efficient proxy for a target asset. For example, in an audio generation embodiment, the modified latent space training representation 210 may be a latent vector that, when passed through a decoder, produces a coherent audio waveform; in a visual embodiment, the modified latent space training representation 210 may represent a compressed feature map that maps to a specific image structure.

Depending on the specific architecture of the generative model system 208, the modification process may vary. For example, if the generative model system 208 utilizes a rectified flow or diffusion-based architecture, the modified latent space training representation 210 may represent the result of an iterative "denoising" or "flow-matching" operation where the generative model system 208 learns the optimal vector path from a high-entropy starting state to a structured target state. Additionally or alternatively, if the generative model system 208 utilizes a transformer-based architecture, the modified latent space training representation 210 may be generated as a sequence of latent tokens that have been refined via self-attention mechanisms to align with the semantic constraints of the training prompt 202.

The discriminator model system 212 may receive the training prompt 202, ground truth data 206, and/or the modified latent space training representation 210 at first timestep (e.g., timestep M). The discriminator model system 212 may generate a training score 214 based on the training prompt 202, ground truth data 206, and/or the modified latent space training representation 210 at first timestep (e.g., timestep M).

The training score 214 may comprise a feedback signal generated by the discriminator model system 212 that represents a measure of divergence between the modified latent space training representation 210 and the ground truth training data 206. Following an evaluation by the discriminator model system 212, the training score 214 can be transmitted to the generative model system 208. The training score 214 may be transmitted to the generative model system 208 via a backpropagation interface. This transmission of the training score 214 can enable the generative model system 208 to perform a score-guided update of its internal parameters, effectively utilizing the training score 214 as a directional vector to iteratively refine the modified latent space training representation 210 in subsequent timesteps. In some embodiments, the generative model system 208 may update its internal parameters via backpropagation based on the training score 214.

Upon receiving the training score 214, the generative model system 208 may also receive the modified latent space training representation 210 from a previous timestep (e.g., timestep M). After the generative model system 208 performs an update of its internal parameters based on the training score 214, the generative model system 208 may execute a subsequent iteration of the training process. In this subsequent iteration, the generative model system 208 can utilize the modified latent space training representation 210 received from the previous timestep (e.g. timestep M), to generate a refined modified latent space training representation 210 at timestep M+N, where N is greater than 0.

In some embodiments, the generative model system 208, having received the training-phase score 214, can update its internal weights based on the gradient of said training score 214 via backpropagation or other appropriate means. Following this weight update, rather than reusing the output of the previous iteration, the generative model system 208 may generate a new instance of a modified latent space training representation 210. This new instance of the modified latent space training representation 210 can be derived from a new set of ground truth training data 206 that has been newly received and/or independently noised. Additionally or alternatively, the new instance of the modified latent space training representation 210 may be derived from the same ground truth data 206 previously received, provided that a different subsample or subset of that ground truth data 206 is utilized.

The training process of the generative model system 208 may be performed for any number of iterations required to reach a threshold of authenticity or alignment of the modified latent space training representation 210. For each distinct training iteration, the generative model system 208 may sample a modified latent space representation 210 from a particular denoising timestep. In some embodiments, for each iteration of the training process, the generative model system 208 may generate a new instance of a modified latent space training representation 210. In other embodiments, a previously generated modified latent space training representation 210 may be utilized in a subsequent iteration of the training process. This training process can continue until the generative model system 208 produces a modified latent space training representation 210 that satisfies the requirements of the discriminator model system 212 or other defined convergence requirements.

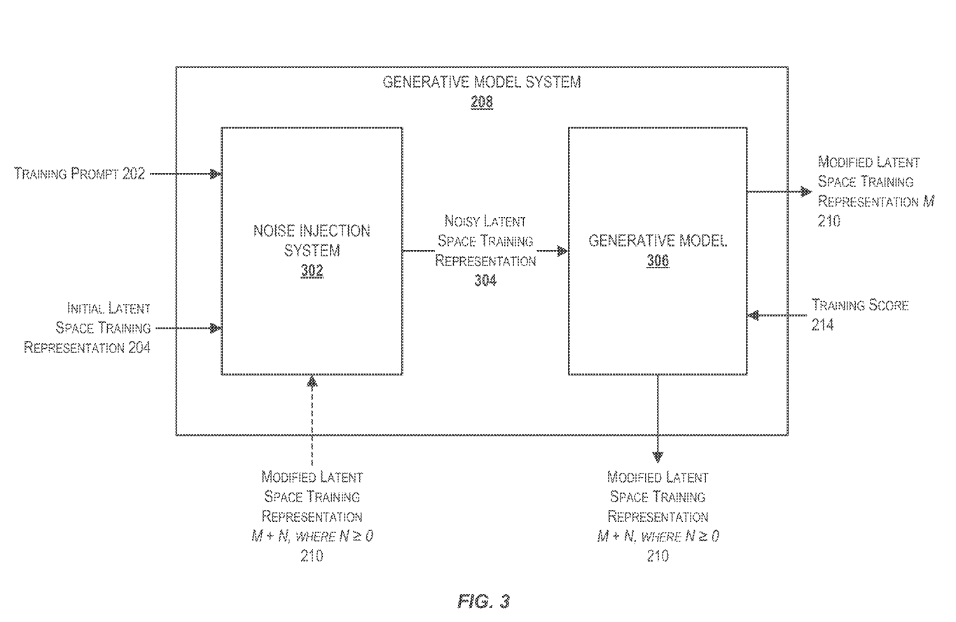

FIG. 3 is a block diagram illustrating an example generative model system 208 (e.g., generative model system 208 described above), according to certain embodiments. The generative model system 208 may include a noise injection system 302 and/or a generative model 306. The generative model system 208 may receive a training prompt 202 (e.g., training prompt 202 described above), an initial latent space training representation 204 (e.g., initial latent space training representation 204 described above), and/or a training score 214 (e.g., training score 214 described above). The generative model system 208 may optionally receive a modified latent space training representation 210 (modified latent space training representation 210 described above) generated at a given timestep. The generative model system 208 may generate a modified latent space representation 210 (e.g., modified latent space training representation 210 described above).

For purposes of clarity, certain elements illustrated in FIG. 3 may be denoted by a timestep identifier to distinguish between recursive stages of the iterative training process. To minimize descriptive redundancy, the specific operations and data flows associated with a timestep M+N are not explicitly illustrated in every instance. However, it should be understood by one of ordinary skill in the art that the technical descriptions, transformations, and operations described with reference to an element at timestep M are equally applicable to corresponding elements at timestep M+N, where N is greater than or equal to 0.

The noise injection system 302 may receive the training prompt 202 and/or the initial latent space training representation 204. The noise injection system 302 may generate a noisy latent space training representation 304 based on the training prompt 202 and/or the initial latent space training representation 204. The noise injection system 302 can prepare the initial latent space training representation 204 for the generative model 306. By intentionally adding “noise” to the initial latent space training representation 204, the noise injection system 302 can ensure the generative model 306 does not merely overfit to the specific samples within the ground truth training data 206, but instead learns the underlying structural and semantic logic of the target asset or content. Furthermore, the noise added to the initial latent space training representation 204 can allow the generative model 306 to generalize its generative capabilities, thereby enabling the generative model 306 to produce assets or content that remain faithful to the training prompt 202 even when faced with imperfect or incomplete input data.

In some embodiments, the noise injection system 302 can perform an operation referred to as additive Gaussian perturbation. During additive Gaussian perturbation, the noise injection system 302 can combine the initial latent space training representation 204, which may be formatted as a vector or a multi-dimensional tensor, with a noise tensor of corresponding dimensions. The additive Gaussian perturbation process may be governed by a noise schedule that dictates the volume or variance of the noise introduced at any given stage of the process. For instance, in the early stages of training, the noise schedule may prescribe heavy noise to force the generative model 306 to identify broad, global structures. In later stages, the schedule may reduce the noise intensity to allow the generative model 306 to focus on the refinement of fine, high-fidelity details.

The noise injection system 302 may be configured to inject various types of noise into the initial latent space representation 204 depending on the requirements of the asset or content being generated. These types of noise may include additive white Gaussian noise, which mimics the random static found in electronic sensors, and shot noise, which simulates the discrete nature of light particles or electrical energy for high-realism renderings. Additionally or alternatively, the noise injection system 302 may employ uniform noise for a non-clustered distribution of corruption, or structured dropout techniques. In a structured dropout configuration, the noise injection system 302 may selectively deactivate specific neurons or dimensions within the initial latent space training representation 204, forcing the generative model 306 to reconstruct missing information from a partial data state.

As an illustrative example, if the training prompt 202 specifies an image to include a clear blue sky, the initial latent space training representation 204 may consist of a vector representing specific values for clarity, texture, and hue. The noise injection system 302 may then generate a noise vector with random positive or negative offsets and combine it with the values of the initial latent space training representation 204. The resulting noisy latent space training representation 304 can then present the generative model 306 with an "out of bounds" or "undesirable" vector (e.g., for example, a vector where colors are unnaturally bright or clarity values are distorted). The generative model 306 may then process the noisy latent space training representation 304 and apply learned generative model 306 parameters to pull the noisy latent space training representation 304 back toward the idealized coordinates associated with the training prompt 202. This can result in a high-fidelity result, such as a modified latent space training representation 210 that, when decoded, results in an asset or content exhibiting the semantic characteristics of the training prompt 202 (e.g., an image of a clear, blue sky).

The generative model 306 can serve as the primary transformation model within the generative model system 208. The generative model 306 may be initialized from a pretrained rectified model. The generative model 306 may be configured to ingest the noisy latent space training representation 304 and, guided by the training prompt 202, map those corrupted or high-entropy data points back toward a coherent, high-fidelity state on the perceptual manifold. In some embodiments, the generative model 306 can include a learnable neural network architecture that iteratively refines its internal weights based on the feedback (e.g., training score 214) received from the discriminator model system 212, as further described herein. Through the training process, the generative model 306 learns to "denoise" and/or synthesize structural details within the initial latent space training representation 204. This training process can ultimately enable the generative model 306 to be optimized into the trained generative model system 106.

In various embodiments, the generative model 306 may be implemented using several machine learning architectures. The machine learning architecture may be selected based on the different advantages each provides for asset synthesis or based on the operational requirements of the adversarial asset generation system 100. For example, the generative model 306 may include a transformer-based architecture, which can utilize self-attention mechanisms to understand complex, long-range dependencies within the training prompt 202 and the initial latent space training representation 204, noisy latent space training representation 304, and/or modified latent space training representation 210. Alternatively, the generative model 306 may include a U-Net architecture, which can handle diffusion-based tasks by utilizing a series of downsampling and upsampling blocks with skip connections to preserve, for example, fine-grained spatial or spectral details while processing the broader structure of the initial latent space training representation 204 and/or modified latent space training representation 210.

The specific logic governing the generative model 306 can be adapted to several generative paradigms based on considerations such as target asset or content modality or the desired computational efficiency of the generative or training process. In a diffusion-based configuration, the generative model 306 may operate as a reverse-diffusion engine that treats the noisy latent space training representation 304 as a state in an iterative sequence (e.g, Markov chain) and learns to predict the specific noise component to be subtracted at each timestep, thereby gradually "revealing" the asset or content from the noise. In a flow-matching engine configuration, the generative model 306 may be trained to learn a vector field that defines the straightest and most efficient path (also referred to as the "flow") from the noisy latent space training representation 304 to the target ground truth training data 206 distribution. In some embodiments, the generative model 306 may function as a Variational Autoencoder (VAE) decoder, serving as the generative half of a VAE framework where the generative model 306 takes sampled latent coordinates from the noisy latent space training representation 304 and expands them into a structured representation that captures the statistical essence of the ground truth training data 206.

During modulation, the generative model 306 can apply a series of non-linear transformations to the noisy latent space training data 304. For instance, if the generative model 306 is tasked with generating a visual asset, it may use the training prompt 202 (e.g., "sharp mountain landscape") to weigh certain structural features more heavily than others. As the generative model 306 processes the noisy latent space training data 304, it can filter out stochastic artifacts (e.g., sensor blur, pixel grain, etc.) and synthesize fine textures that align with the "sharp" and "landscape" descriptors of the training prompt 202. Examples of such synthesized textures may include, in this example, the jagged edges of mountain formations or the crystalline patterns of snow. The resulting output, the modified latent space training representation 210 generated at timestep M, can be a mathematically dense and semantically organized representation.

Following the generation of the modified latent space training representation 210 at timestep M, the generative model system 208 may initiate a recursive refinement cycle to further enhance the fidelity of the modified latent space training representation 210. Thus, the modified latent space training representation 210 from timestep M may be fed back into the noise injection system 302, where it can undergo a subsequent round of stochastic modulation. By re-introducing a controlled level of noise to this already-refined modified latent space training representation 210 from timestep M, the noise injection system 302 can generate a new noisy latent space training representation 304 as input for the generative model 306. This can allow the generative model 306 to perform another sequence of non-linear transformations that leverages the updated internal parameters of the generative model 306, which have been refined based on the training score 214, to resolve even finer details or correct any remaining artifacts in the new noisy latent space training representation 304. This iterative loop may continue until a final modified latent space training representation 210 is produced at timestep M+N, where N is greater than or equal to 0, and where this final modified latent space training representation 210 is an optimized representation that satisfies the perceptual and/or structural requirements of the target asset or content. In some embodiments, the iterative loop may simply conclude upon reaching a predetermined timestep. Once the iterative process is complete, the modified latent space training representation 210 may be transmitted by the generative model 306 for further downstream processing, such as for conversion into a human-perceivable format by a decoder.

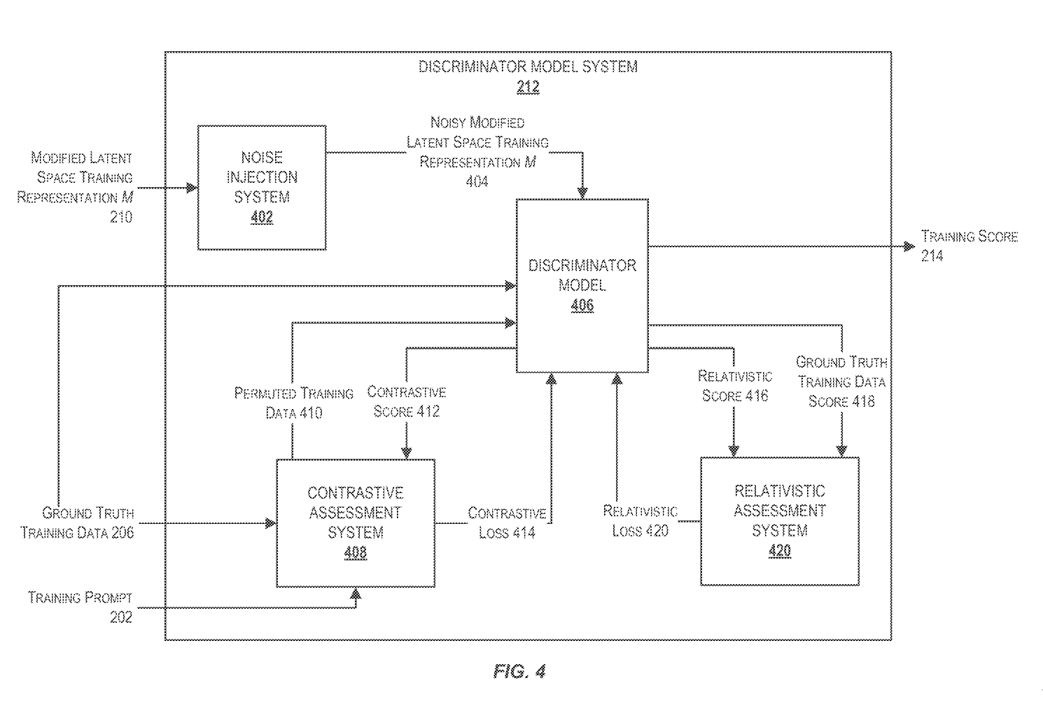

FIG. 4 is a block diagram illustrating an example discriminator model system 212 (e.g. discriminator model system 212 described above), according to certain embodiments. The discriminator model system 212 may include a noise injection system 402, a discriminator model 406, a contrastive assessment system 408, and/or a relativistic assessment system 420. The discriminator model system 212 may receive a training prompt (e.g., training prompt 202 described above), ground truth training data 206 (e.g., ground truth training data 206 described above), and/or a modified latent space training representation 210 (e.g., modified latent space training representation 210 described above). The discriminator model system 212 may generate a training score 214 based on the training prompt, ground truth training data 206, and/or the modified latent space training representation 210.

For purposes of clarity, certain elements illustrated in FIG. 2 may be denoted by a timestep identifier to distinguish between recursive stages of the iterative training process. To minimize descriptive redundancy, the specific operations and data flows associated with a timestep M+N are not explicitly illustrated in every instance. However, it should be understood by one of ordinary skill in the art that the technical descriptions, transformations, and operations described with reference to an element at timestep M are equally applicable to corresponding elements at timestep M+N, where N is greater than or equal to 0.

The discriminator model system 212 is configured to analyze the modified latent space training representation 210 received from the generative model system 208 identify high-dimensional features indicative of perceptual fidelity. In some embodiments, the discriminator model system 212 may evaluate the modified latent space training representation 210 determine their degree of alignment with the training prompt 202 and/or the ground truth training data 206. Specifically, the discriminator model system 212 may evaluate the structural coherence and semantic alignment of the modified latent space training representation 210 relative to the training prompt 202 and/or the ground truth training data 206, ensuring that the modified latent space training representation 210 generated by the generative model system 208 conforms to training prompt 202 and/or the underlying manifold of the ground truth training data 206. This evaluation performed by the discriminator model system 212 can then provide the basis for the training score 214, which can then guide the refinement of the internal parameters of the generative model system 208, thereby refining subsequent outputs toward an high-fidelity target state.

The noise injection system 402 can be configured to receive the modified latent space training representation 210 and generate a noisy modified latent space training representation 404. By introducing a controlled amount of variance or "noise" to the output of the generative model 306, the noise injection system 402 can ensure that the discriminator model system 212 evaluates a broader distribution of data points rather than a single, static result. In other words, the noise injection system 402 can prevent the discriminator model system 212 from overfitting to specific, narrow artifacts in the modified latent space training representation 210, thereby compelling the discriminator model system 212 to learn a more robust and generalized representation of what constitutes a target asset or content.

In some embodiments, the modified latent space training representation 210 may be transmitted to the discriminator model system 212 directly, without the addition of noise. Transmitting the modified latent space training representation 210 without adding noise may be done once the generative model system 208 has reached a stability threshold where additional stochastic variance to the modified latent space training representation 210 generated by the generative model system 208 is no longer required to prevent mode collapse. Mode collapse can refer to a generative failure wherein the generative model system 208 produces a limited, repetitive set of outputs (i.e., modified latent space training representations 210) concentrated on a few modes (i.e., high-probability clusters of data) of the data distribution (e.g., a specific audio pitch or visual texture). If the generative model system 208 fixates on these limited modes, the generative model system 208 may fail to capture the full diversity of the target asset or content class. Furthermore, noise injection may be bypassed in scenarios where the modified latent space training representation 210 is already sufficiently refined to ensure a robust evaluation by the discriminator model system 212.

The noise introduced by the noise injection system 402 to the modified latent space training representation 210 may comprise various forms of stochastic perturbation tailored to the target asset's modality. For example, in visual or spectral domains, this may include additive white noise to simulate sensor variance, multiplicative noise (such as speckle noise) to account for signal interference, or latent jittering, which involves shifting the representation's coordinates by a negligible fractional value. In other embodiments, the noise injection system 402 may use dropout-based noise, where certain features of the modified latent space training representation 210 are randomly masked.

In embodiments where the adversarial asset generation system 100 is configured to produce audio assets, the noise injection system 402 may introduce stochastic perturbations specifically designed to simulate the acoustic and/or technical variances inherent in audio/sound recording and reproduction. This may involve the application of spectral dithering, which is a technique used in audio signal processing that introduces low-level randomized signals across the frequency spectrum to prevent the discriminator model system 212 from relying on unnatural latent data artifacts, such as digital silence or "perfect" frequency cutoffs. Additionally, the noise injection system 402 may introduce temporal or phase jitter, such as by shifting the timing of the modified latent space training representation 210 by fractional amounts, to ensure the discriminator model system 212 evaluates the fundamental rhythmic and harmonic integrity of the audio asset rather than the audio asset’s exact digital alignment. The incorporation of simulated ambient floor noise (i.e., unwanted background sound) or quantization artifacts by the noise injection system 402 to produce a noisy modified latent space training representation 404 can challenge the discriminator model system 212 to look beyond superficial digital artifacts and instead evaluate the underlying structural and semantic integrity of the asset.

By presenting the discriminator model system 212 with these "noisy" variations (i.e., the noisy modified latent space training representation 404), the noise injection system 402 can force the discriminator model system 212 to ignore superficial, low-level artifacts and instead focus on the high-level semantic and structural integrity of the noisy modified latent space training representation 404. A beneficial result of adding noise is that it can prevent the discriminator from becoming a "memorizer" of specific generator model system 208 outputs.

The discriminator model 406 may receive the noisy modified latent space training representation 404 and/or the ground truth training data 206. The discriminator model system 406 may include or may be initialized from a pretrained rectified model. In some embodiments, the discriminator model system 406 may include or be initialized from a pretrained diffusion model. The discriminator model 406 may additionally receive permuted training data 410, a contrastive loss 414, and/or a relativistic loss 420. The discriminator model 406 may generate a contrastive score 412, relativistic score 416, and/or a ground truth training data score 418. The discriminator model 406 may additionally generate the training score 214.

The discriminator model system 212 may be implemented as a deep neural network architecture configured for high-dimensional classification and feature extraction. For example, the discriminator model system 212 may include a Convolutional Neural Network (CNN), which is can be effective for identifying spatial hierarchies and structural patterns in visual or spectral data. In some embodiments, the discriminator model system 212 may be implemented as a Transformer-based architecture or a Recurrent Neural Network (RNN). The RNN architecture may be selected to, for example, evaluate temporal coherence and long-range dependencies within the modified latent space training representation 210. In some embodiments, the discriminator model system 212 may also utilize Vision Transformers (ViT) or Multi-Layer Perceptrons (MLP) to assess the semantic alignment of the generated content. The discriminator model system 212 can be configured to map the input representation (e.g., modified latent space training representation 210, noisy modified latent space training representation 404) to a scalar value or probability distribution that indicates the likelihood that the modified latent space training representation 210 and/or noisy modified latent space training representation 404 conforms to the ground truth training data 206.

The discriminator model system 212 may be configured to facilitate the derivation of two distinct, complementary metrics: a contrastive score 412 and a relativistic score 416. Together, the contrastive score 412 and the relativistic score 416 can allow the discriminator model system 212 to provide a multi-dimensional feedback signal (i.e., the training score 214) to the generative model 306 to optimize for both semantic accuracy and similarity alignment. Semantic accuracy can refer to the evaluation of whether the generated modified latent space training representation 210 conforms to the specific conceptual parameters and intent defined by the training prompt 202. For example, in the context of semantic accuracy, if the training prompt 202 specifies "a grand piano playing a jazz melody," the evaluation can determine if the generative model 306 actually synthesized a piano sound following that specific musical genre rather than, for instance, a violin or a rock-style guitar. Similarity alignment can refer to the evaluation of whether the generated modified latent space training representation 210 achieves high-dimensional fidelity and distributional consistency relative to the ground truth training data 206. For example, in the context of similarity alignment, the evaluation determines whether a synthesized piano sound possesses high-dimensional acoustic characteristics (e.g, the vibration of piano strings, the sharpness of piano key strikes, the natural echo of the room, etc.) that correspond to those found in the ground truth training data 206 in order to emulate an actual physical instrument rather than a flat, synthetic approximation.

### A. Contrastive Asessement

To evaluate semantic accuracy, the contrastive assessment system 408 may first ingest the training prompt 202 and/or the ground truth training data 206. The contrastive assessment system 408 can be configured to generate permuted training data 410 by cross-referencing the training prompt 202 and/or the ground truth training data 206 to create aligned and misaligned data pairs. Based on an analysis of these pairs, the discriminator model 406 is then tasked to assess which pair is “correct” or “real,” meaning the pair in which the high-dimensional features of the latent representation are most statistically and semantically consistent with its paired training prompt. The contrastive assessment system 408 may then produce a contrastive score 412, which represents the distance between the generated asset and its semantic intent. This contrastive score 412 can be subsequently utilized to derive a contrastive loss 414, which can serve to provide a differentiable gradient that quantifies the degree of semantic misalignment. This contrastive loss 414 can then be used in guiding the generative model 306 to iteratively minimize the mathematical distance between its outputs and the intended semantic concept, as will be described in greater detail below.

In some embodiments, the contrastive score 412 may represent the relative distance or gap between the semantically aligned (i.e., “real”) pairing and the misaligned (i.e., “fake”) pairing. This distance or gap can act as a differential metric (e.g., training score 214) used to optimize the generative model 306 to produce modified latent space training representations 210 that minimize this distance. By minimizing this distance, the generative model 306 is optimized to generate modified latent space representations 210 that are judged by the discriminator model 406 to as similar or indistinguishable from the authentic reference assets (e.g., ground truth training data 206) utilized during the training phase.

The contrastive assessment system 408 may generate permuted training data 410 by cross-referencing the ground truth training data 206 with the training prompt 202. The permuted training data 410 may comprise a set of data pairs, including at least one positive pair and at least one negative pair. The first pair (i.e., the positive pair) includes the latent space representation of the target asset from the ground truth training data 206 paired with the corresponding training prompt 202; this pair is semantically aligned. The second pair (i.e., the negative pair) includes the latent space representation of said target asset paired with an unassociated prompt that is semantically distinct or mismatched; this pair is not semantically aligned. The unassociated prompt utilized in the negative pair may be generated by sampling a training prompt 202 associated with a different, unrelated asset from the ground truth training data 206. In some embodiments, this unassociated prompt may be retrieved from an external source, such as a remote data store or a pre-defined dictionary of mismatched semantic labels, and provided to the contrastive assessment system 408 to facilitate the comparative evaluation.

The discriminator model system 212 may receive the permuted training data 410 (i.e., the positive and negative pairs) and may process each pair to evaluate their relative semantic association. The discriminator model 406 may utilize a relativistic contrastive loss mechanism to process the permuted training data 410. Specifically, the discriminator model 406 may generate independent scores for each pair in the permuted training data 410. The discriminator model system 212 can be optimized to maximize the difference between the scores of semantically aligned (positive) pairs and semantically misaligned (negative) pairs. This relativistic approach focuses the training on the comparative "gap" between the "real" (aligned) and "fake" (misaligned) pairings. The resulting evaluation, which represents this relative difference in semantic alignment, can then be output as the contrastive score 412 to the contrastive assessment system 408 for further processing.

In some embodiments, the discriminator model system 212 may receive the permuted training data 410 (i.e., the positive and negative pairs) and process each pair to determine the level of mutual information shared between the latent space representation of the target asset and its respective prompt pairing. Specifically, the discriminator model 406 can map both the modified latent space training representation 210 and the training prompt 202 into a shared embedding space. For each pair, the discriminator model 406 may calculate or determine a similarity value (e.g. dot product or cosine similarity) to measure how well the features of the asset "match" the description in the prompt. By evaluating the positive and negative pairs simultaneously, the discriminator model system 212 identifies the subtle high-dimensional patterns that signify a correct semantic association. The resulting evaluation can reflect the discriminator model’s 406 confidence in the semantic alignment of the positive pair relative to the negative pair and can then be output as the contrastive score 412. The contrastive 412 may be received by the contrastive assessment system 408 for further processing.

Once the contrastive assessment system 408 receives the contrastive score 412, the contrastive assessment system 408 can determine a contrastive loss 414 by applying an objective function (e.g., Triplet Loss, InfoNCE) designed to maximize the similarity between the training prompt 202 and its corresponding ground truth training data 206 while simultaneously maximizing the distance in the latent space between the ground truth training data 206 and unassociated or mismatched prompts. The discriminator model 406 can receive the contrastive loss 414 as a supervised feedback signal to iteratively refine its internal feature extractors throughout the training process. During this phase, the discriminator model 406 may aim to minimize the contrastive loss 414 by optimizing its parameters to more accurately distinguish between aligned and misaligned pairs within the permuted training data 410. When a high contrastive loss 414 is detected, this can indicate that the discriminator model 406 failed to clearly differentiate the positive pair from the negative pair in the latent space. To correct this, the discriminator model 406 can calcualte the gradient of the contrastive loss 414 with respect to the discriminator model’s 406 neural weights. Through an optimization algorithm like stochastic gradient descent, the discriminator model 406 can adjust these weights to tighten the clustering of semantically related data while pushing unrelated data further apart in the shared embedding space. This iterative refinement can force the discriminator model 406 to identify increasingly subtle nuances.

For example, if the discriminator model 406 initially assigns similar scores to a piano sound paired with a piano prompt and a piano sound paired with a harpsichord prompt, the resulting contrastive loss 414 will be high. To train itself, the discriminator model 406 may adjust its weights or parameters to focus on the specific attack and decay patterns that distinguish the two instruments, eventually learning to push the harpsichord prompt further away from the piano audio in the latent space. Similarly, the discriminator model 406 may use the contrastive loss to learn which audio features are true semantic indicators and which are merely background interference. Minimizing the contrastive loss 414 can result in the discriminator model 406 training itself to ignore the noise and focus on the core feature signatures that align with the training prompt 202.

The discriminator model 406 and the contrastive assessment system 408 may engage in an iterative and recursive feedback loop that continuously improves the semantic precision of the discriminator model 406. For example, the contrastive loss 414 generated at a first timestep can be fed back into the discriminator model 406 to update its internal weights and feature-detection filters via backpropagation. As the discriminator model 406 adapts its parameters to minimize the contrastive loss 414, the discriminator model 406 may become increasingly adept at identifying subtle semantic inconsistencies within the permuted training data 410. This increased sensitivity serves to elevate the standards of the next training iteration, creating a more complex classification landscape that the discriminator model 406 must uphold.

Furthermore, as will be discussed in greater detail herein, the contrastive loss 414 can be used when generating the training score 214 that the generative model system 208 then uses to improve itself. Therefore, as the discriminator model 406 gets better at picking the correct pair, the contrastive loss 414 may get smaller. This in turn will make the overall training score 214 more mathematically rigorous, which in turn can require the generative model system 208 to achieve a higher degree of latent alignment to meet the increasingly stringent convergence criteria. In other words, the training score 214 may optimize generative model system 208 to minimize the contrastive loss 414 by producing a modified latent space training representations 210 that the discriminator perceives as being as semantically valid (or as “real”) as the ground truth training data 206.

### B. Relativistic Assessment

The relativistic assessment system 420 may receive a relativistic score 416 and/or ground truth training data score 418. The relativistic assessment system 420 may generate a relativistic loss 420 based on the relativistic score 416 and/or the ground truth training data score 418. The relativistic assessment system 420 can be configured to evaluate the discriminator model’s 406 ability to determine a comparison between a noisy modified latent space training representation 404 (or modified latent space training representation 210) and the latent space representation of the target asset derived from the ground truth training data 206.

The discriminator model 406 may be configured to generate the relativistic score 416 by assigning a value to the noisy modified latent space training representation 404 (or the modified latent space training representation 210) while simultaneously generating a ground truth training data score 418 by processing the latent space representation of the target asset derived from the ground-truth training data 206. The difference between the relativistic score 416 and the ground truth training data score 418 can represent the distance or “gap” between how “real” the discriminator model 406 perceives the noisy modified latent space training representation 404 (or the modified latent space training representation 210) as compared to the latent space representation of the target asset.

In this context, the “realness” of the noisy modified latent space training representation 404 (or the modified latent space training representation 210) can refer to how closely its mathematical structure and data patterns match those of the actual ground truth training data 206. The discriminator model 406 can be configured to maximize the scoring "gap" by getting better at spotting even tiny differences between the noisy modified latent space training representation 404 (or the modified latent space training representation 210) and the real asset (e.g., ground truth training data 206). This maximization between the relativistic score 416 and the ground truth training data score 418 can optimize the generative model 306. Specifically, the generative model 306 may be configured to minimize the difference between the relativistic score 416 and the ground truth training data score 418 by generating improved modified latent space representations 210. This can eventually result in the generative model 306 producing modified latent space training representations 210 that are judged by the discriminator model 406 to be as similar to the ground-truth training data 206 as possible. In some embodiments, this may result in modified latent space training representations 210 deemed “more real,” as in achieving a state where the discriminator model’s 406 score for the modified latent space training representations 210 is statistically equal to or higher than the score for the original reference asset (e.g., ground truth training data 206).

In some embodiments, the discriminator model 406 can be configured to generate the relativistic score 416 by analyzing the noisy modified latent space training representation 404 or the modified latent space training representation 210 and outputting a value that represents the probability that the synthesized asset is authentic. Simultaneously, the discriminator model 406 can generate the ground truth training data score 418 by processing the latent space representation of the target asset derived from the ground truth training data 206. Through this dual analysis, the discriminator model 406 can determine whether the latent representation produced by the generative model system 208 or the latent representation derived from the ground truth training data 206 exhibits a higher level of perceptual fidelity or statistical authenticity.

As described herein, the discriminator model 406 can quantify perceptual fidelity or statistical authenticity by measuring the divergence between the feature distributions of synthesized assets (i.e., modified latent space training representation 210, noisy modified latent space training representation 404) and the feature distribution generated based on the ground truth training data 206. The discriminator model 406 can learn to identify these divergences between these feature distributions through the iterative application of relativistic loss functions, which can estimate the probability that a given ground truth sample is "more real" than a synthesized sample. Specifically, instead of mapping an input (e.g., modified latent space representation 210) to a single, absolute scalar, the relativistic loss function can force the discriminator model system 212 to predict the likelihood that the “real” ground truth training data 206 possesses higher perceptual fidelity or statistical authenticity than the modified latent space training representation 210.. Additionally or alternatively, the discriminator model 406 can identify specific acoustic or visual patterns, such as the presence of natural harmonics or the absence of aliasing artifacts, to assign a numerical value to the realism of the modified latent space training representation 210.

This adversarial process creates a symmetrical learning signal: while the discriminator model 406 is penalized if it fails to distinguish the "real" (e.g., ground truth training data 206) from the "generated" (e.g., modified latent space representation 210) pairing, the generative model 306 is simultaneously optimized to reduce this relativistic gap. Through this comparative feedback loop, the discriminator model 406 identifies specific acoustic or visual patterns, such as the presence of natural harmonics or the absence of aliasing artifacts, to assign a numerical value to the realism of the modified latent space training representation 210.

Thus, the discriminator model 406 can serve as a relativistic evaluator that does not merely judge each latent space representation in isolation, whether that representation is generated by the generative model system 208 or provided via the ground truth training data 206. Instead, the discriminator model 406 estimates the likelihood that the ground truth training data 206, or other data representing a target state of the asset, is more realistic than the synthesized modified latent space training representation 210.

The relativistic score 416 can represent the judgment of the discriminator model 406 regarding the modified latent space training representation 210 or the noisy modified latent space training representation 404 relative to the average realism of the “real data,” which may be derived from the ground truth training data 206 or an external source defining the target asset or content characteristics. Conversely, the ground truth training data score 418 can represent the judgment of this “real data” derived from the ground truth training data 206 or an external source defining the target asset characteristics.

The discriminator model 406 can provide the relativistic assessment system 420 with the relativistic score 416 and/or the ground truth training data score 418. The relativistic assessment system 420 can generate a relativistic loss 422 by calculating the mathematical difference between the relativistic score 416 and the ground truth training data score 418. This loss function can represent a shifting probability, where the discriminator model 406 predicts the likelihood that the latent representation derived from the ground truth training data 206 exhibits a higher level of perceptual fidelity or statistical authenticity compared to the modified latent space training representation 210.

The relativistic loss 422 can serve as a training signal that enables the discriminator model 406 to refine its own internal parameters. By minimizing this loss, the discriminator model 406 can learn to maximize the probability gap between authentic (e.g., ground truth training data 206 or latent representations derived from the ground truth training data 206) and synthetic data (e.g., modified latent space training representation 210, noisy modified latent space training representation 404), thereby training itself to become more sensitive to the features that distinguish the ground truth training data 206 from the modified latent space training representation 210. This internal refinement process can allow the discriminator model 406 to provide a stable and continuous gradient for the generative model system 208 to follow during the training cycle.

As described herein, the relativistic loss 422 can be utilized when generating the training score 214 that the generative model system 208 may use for self-improvement and updating of its weights or parameters. As the discriminator model 406 enhances its ability to differentiate the relative authenticity of the ground truth training data 206 compared to the modified latent space training representation 210, the relativistic loss 422 can decrease in magnitude. This reduction in the relativistic loss 422 can result in a training score 214 that is more statistically demanding, which can necessitate that the generative model system 208 produces assets with higher perceptual fidelity to satisfy the narrowing probability gap established by the relativistic assessment system 420. Consequently, this comparative feedback loop can force the generative model system 208 to continuously refine its modified latent space training representations 210 for greater perceptual fidelity or statistical authenticity.

### C. Training Score

The discriminator model 406 can utilize the contrastive loss 414 and the relativistic loss 422 as distinct yet complementary training signals to refine its evaluative precision. When operating independently, the contrastive loss 414 can enable the discriminator model 406 to focus on semantic alignment by learning the specific relationships between an input prompt and a synthesized asset. By minimizing the contrastive loss 414, the discriminator model 406 can improve its internal feature-mapping filters to ensure that a generated asset correctly reflects the conceptual intent of the training prompt 202. Separately, the relativistic loss 422 can be used by the discriminator model 406 to focus on statistical realism. In this mode, the discriminator model 406 can train itself to measure the diminishing gap between the ground truth training data 206 and the modified latent space training representation 210, effectively becoming a more sensitive judge of high-fidelity textures and acoustic nuances.

In some embodiments, the contrastive loss 414 and the relativistic loss 422 can be combined to provide a multi-dimensional feedback signal for the discriminator model 406 to improve itself. The discriminator model 406 can simultaneously learn to enforce semantic accuracy and structural authenticity using both the semantic loss 414 and the relativistic loss 422. For instance, the discriminator model 406 can utilize the contrastive loss 414 to ensure a generated sound is indeed a "piano" while concurrently utilizing the relativistic loss 422 to ensure that the piano sound is as realistic as the samples found in the ground truth training data 206. By optimizing for both the semantic loss 414 and the relativistic loss 422, the discriminator model 406 can avoid "mode collapse," where a model might produce realistic sounds that do not match the user's prompt, or semantically accurate sounds that lack perceptual fidelity.

The contrastive loss 414 and the relativistic loss 422 can be combined to generate a comprehensive training score 214 through various mathematical combinations. This combination can be performed by calculating a weighted sum of the two losses, which may allow the training process of the discriminator model 406 to prioritize contrastive assessment or relativistic assessment depending on the current state of the discriminator model 406. For example, the two losses can be scaled using hyperparameter coefficients so that one loss is more impactful than the other. In the early stages of training, for instance, the contrastive loss 414 might be scaled higher to prioritize teaching the discriminator model 406 basic semantic associations. As the discriminator model 406 improves, the scaling can be adjusted to favor the relativistic loss 420, shifting the focus toward achieving ultra-high fidelity and indistinguishable realism.

In some embodiments, the contrastive loss 414 and the relativistic loss 420 can be combined non-linearly or through a gated mechanism within the relativistic assessment system 420 and the contrastive assessment system 408. The training score 214 can be derived by taking the geometric mean or a maximum function of the two losses, which can result in ensuring that the generative model system 208 is penalized heavily if either the semantic alignment or the statistical realism falls below a certain threshold.

In some embodiments, because the discriminator model 406 is trained jointly on both the contrastive loss 414 and the relativistic loss 420, the training score 214 may be a single scalar output that inherently encapsulates both the contrastive loss 414 and the relativistic loss 420. By consolidating both the contrastive loss 414 and the relativistic loss 420 into a single training score 214, the discriminator model system 212 can ensure that the generative model system 208 treats prompt accuracy and perceptual quality as a singular, integrated optimization target, thereby preventing the generative model system 208 from prioritizing one characteristic at the expense of the other.

The generative model system 208 can utilize the training score 214 as a feedback signal to guide the optimization of the generative model 306. During the training phase, the training score 214, which encapsulates the combined insights of the contrastive loss 414 and the relativistic loss 422, can be propagated back through the neural architecture of the generative model 306. This process, which can involve backpropagation and gradient descent, may allow the generative model 306 to identify which specific internal weights and neurons contributed to the residual error represented by the training score 214. The generative model 306 can perform incremental updates that shift its output (e.g., modified latent space training representations 210) closer to the high-fidelity target state by calculating the gradient of the training score 214 with respect to its own parameters.

In some embodiments, the training process of the generative model system 208 may employ a dual-objective strategy that transitions based on the signal-to-noise ratio of the modified latent space training representation 210. When the adversarial asset generation system 100 operates in a high-noise regime, typically during the initial stages of diffusion or when the noise level exceeds a predetermined threshold, the generative model 306 may be primarily guided by a rectified loss. This rectified loss can focus on the fundamental reconstruction of the target asset, providing a stable gradient for the model to learn the coarse structural components of the asset. As the noise level decreases and the modified latent space training representation 210 enters a low-noise regime, the adversarial asset generation system 100 can shifts its reliance toward the discriminator model 406 and the associated relativistic score 416 and contrastive score 412. At these lower noise levels, the discriminator model 406 can act as a high-resolution evaluator that captures fine-grained spectral and temporal details that a standard reconstruction loss might overlook. Dynamically balancing these objectives geared towards high or low noise regimes can allow the adversarial asset generation system 100 to ensure that the generative model 306 is first grounded in structural accuracy before being challenged to achieve the ultra-high perceptual fidelity required for the final target state.

The training process can be viewed as an iterative refinement of the generative model's 306 internal mapping between the training prompt 202 and the resulting asset (e.g., modified latent space training representation 210). As the generative model 306 receives a sequence of training scores 214, it can learn to suppress features that the discriminator model 406 flagged as unrealistic while amplifying features that align with the ground truth training data 206.

For example, if the generative model 306 is tasked with synthesizing a "thunderstorm" sound effect and the training score 214 is high (or the training score 214 otherwise indicates a larger relativistic difference or “gap”) due to a lack of low-frequency resonance, the generative model 306 can adjust its parameters or weights to emphasize deeper bass frequencies in the next iteration. This training process, by utilizing both the contrastive loss 414 and the relativistic loss 422 within the training score 214, can train the generative model 306 to move beyond the production of random audio and specifically target the acoustic characteristics that satisfy the rigorous criteria of the relativistic assessment system 420.

In another example involving semantic alignment, the generative model 306 might produce a modified latent space training representation 210 for the prompt 202 of "glass breaking" that sounds too metallic. The contrastive loss 414 within the training score 214 could indicate a semantic mismatch, signaling that the generated latent features are drifting too far from the "glass" category or “glass” subspace in the embedding space. To improve itself, the generative model 306 can recalibrate its feature generators to favor the high-pitched, sharp features associated with glass shards rather than the sustained ringing of metal.

In some embodiments, training score 214 can be dynamically scaled by the relativistic assessment system 420 and the contrastive assessment system 408 to emphasize specific learning objectives or to increase the penalties for certain types of synthetic errors. By applying weighting coefficients to the individual components of the training score 214 (i.e., contrastive loss 414, relativistic loss 420), the training score 214 can guide the generative model 306 to prioritize particular attributes, such as semantic adherence over raw acoustic fidelity, during different stages of the training cycle.

For example, if the generative model 306 consistently produces modified latent space training representations 210 that are realistic but fail to match the intent of the training prompt 202, the contrastive loss 414 can be scaled upward to heavily penalize semantic drift. Conversely, the training score 214 can be weighted to emphasize the relativistic loss 422 if the goal is to fine-tune the high-frequency textures of the modified latent space training representations 210 to more closely match the ground truth training data 206. This modular scaling capability can allow the generative model 306 to be selectively penalized for specific artifacts or misalignments to improve the generative model 306 such that the generative model 306 converges on a target state that satisfies the requirements of the prompt 202.

At the conclusion of the training phase, which may be determined by the generative model system 208 reaching a predetermined number of timesteps or by achieving a specific state of convergence defined by the training score 214, the generative model system 208 can be transitioned into a production-ready state. At this stage, the optimized parameters, weights, and internal architectures of the generative model 306 are finalized, allowing the generative model system 208 to be deployed as the trained generative model system 106 (e.g., trained generative model system 106 discussed above). This deployment can signify that the generative model 306 has attained a sufficient level of latent alignment and statistical authenticity to perform inference tasks without the further need for the discriminator model system 212.

Once deployed, the trained generative model system 106 can be configured to generate high-fidelity modified latent space representations 108 (e.g., modified latent space representation 108 discussed above) based on inputs such as a prompt 102 (e.g., prompt 102 discussed above) and/or an initial latent space representation 104 (e.g., initial latent space representation 104 discussed above). Because the trained generative model system 106 was optimized against the ground truth training data 206, the trained generative model system 106 can synthesize these modified latent space representations 108 such that they encapsulate the complex multidimensional features, including spectral density, temporal patterns, and semantic nuances, required to represent a target asset.

In some embodiments, the modified latent space representations 108 can serve as the foundational data from which a final physical or digital asset is reconstructed.

### II. METHOD

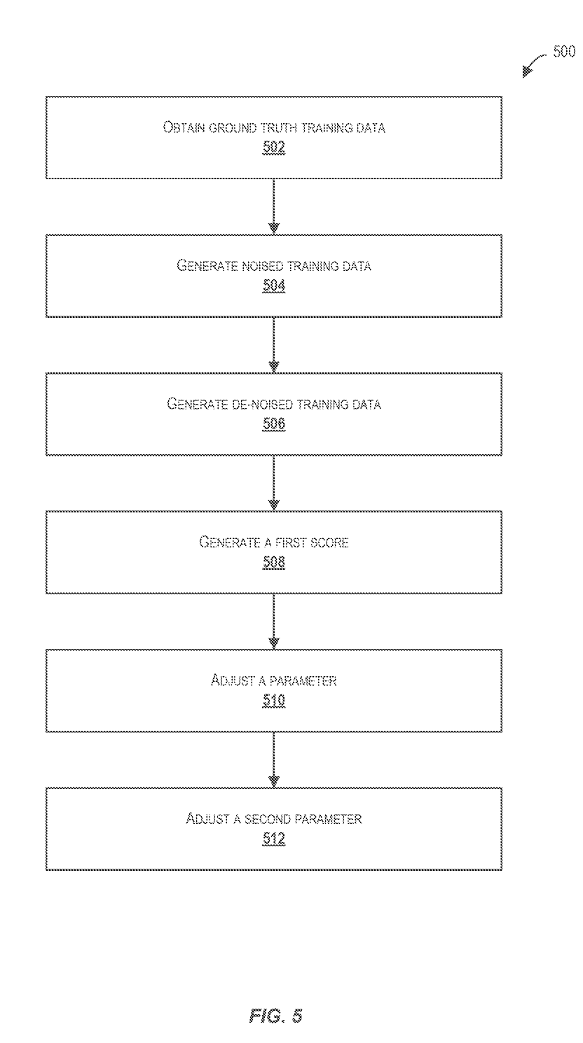

The processing performed using the inference system architecture described above with respect to FIGS. 1-4 may be implemented using an adversarial asset generation method. Examples of such methods are described below with respect to method 500 as depicted in FIG. 5.

The processing depicted in method 500 and any other FIGS. may be implemented in software (e.g., code, instructions, program) executed by one or more processing units (e.g., processors, cores) of the respective systems, using hardware, or combinations thereof. The software may be stored on a non-transitory storage medium (e.g., on a memory device). The method presented in method 500, and other FIGS. and described herein are intended to be illustrative and non-limiting. Although method 500, and other FIGS., depict the various processing steps occurring in a particular sequence or order, this is not intended to be limiting. In certain alternative embodiments, the processing may be performed in some different order or some steps may also be performed in parallel. It should be appreciated that in alternative embodiments the processing depicted in method 500, and other FIGS., may include a greater number or a lesser number of steps than those depicted in the respective FIGS.

FIG. 5 is a block diagram illustrating an example method 500 of using an adversarial asset generation system, according to certain embodiments of the present disclosure. The method may be performed by the adversarial asset generation system 100 described above.

At S502, ground truth training data (e.g., ground truth training data 206). The ground training data may include first content (e.g., initial latent space training representation 204). In some embodiments, the ground truth training data can include a first latent space representation of the first content. The ground truth training data may include first content, such as audio data, and a training prompt that corresponds to the first content. This ground truth data can serve as the target distribution for the system (e.g., adversarial asset generation system), providing the objective reference for both the semantic content and the high-fidelity characteristics that the generative model (e.g., generative model 306) seeks to replicate.

In some embodiments, the ground truth training data may comprise audio data.

At S504, noisy training data (e.g., noisy latent space training representation 304) may be generated. The noisy training data may be generated by adding noise to the ground truth training data.

At S506, de-noised training data (e.g., modified latent space training representation 210 at timestep M) may be generated. In some embodiments, the de-noised training data may be a continuous latent representation defined by a sequence of floating-point values.

In some embodiments, a second de-noised training data (e.g, modified latent space training representation 210 at timestep M+N) may be generated based at least in part on the first score such that the second de-noised training data optimizes a second score determined by the discriminator model. The parameter of the discriminator model may be adjusted based at least in part on the second score. The second parameter of the generative model may be adjusted based at least in part on the second score.

In some embodiments, the first score and second score may be based at least in part on a similarity score (e.g., relativistic loss 420) and a semantic score (e.g., contrastive loss 414). The similarity score may represent a degree of similarity between a corresponding one of the de-noised training data or the second de-noised training data and the ground truth training data. The semantic score may represent semantic alignment of the ground truth training data. The similarity score may be generated by the discriminator model determining a difference between a value assigned to the de-noised training data and a value assigned to the ground truth training data. The semantic score may be generated by the discriminator model comparing a first pairing of the ground truth training data with the training prompt and a second pairing of the ground truth training data with an unassociated prompt. An unassociated prompt may be a prompt that is semantically distinct or mismatched from the data with which it is paired.

At S508, a first score (e.g., training score 214) may be generated. The de-noised training data may be generated based at least in part on inputting the noisy training data to a generative model (e.g., generative model 306).

At S510, a parameter may be adjusted. The parameter being adjusted may be a parameter of the discriminator model (e.g., discriminator model 406). The parameter may be adjusted based at least in part on the first score.

At S512, a second parameter may be adjusted. The second parameter being adjusted may be a parameter of the generative model. The parameter may be adjusted based at least in part on the first score.

In some embodiments, the prompt, training prompt, and the unassociated prompt may comprise natural language text.

The parameter of the discriminator model may be adjusted with an objective to maximize the difference between a metric (e.g. ground truth training data score 418) assigned to the ground truth training data and a metric (e.g., relativistic score 416) assigned to a subsequent de-noised training data. The second parameter of the generative model may be adjusted with an objective to minimize the difference between the metric (e.g. ground truth training data score 418) assigned to the ground truth training data and the metric (e.g., relativistic score 416) assigned to the subsequent de-noised training data.

At least one of the generative model or the discriminator model may be initialized from a pretrained rectified model.

In some embodiments, a prompt (e.g., prompt 102) an initial data sample (e.g., initial latent space representation 104) may be obtained. Based at least in part on inputting the prompt and the initial data sample to the generative model (e.g., trained generative model system 106) comprising the adjusted second parameter, inference data (e.g., modified latent space representation 108) may be generated.

In some embodiments, a noise level associated with the noisy training data may be determined. The second parameter of the generative model may be adjusted in response to the noise level exceeding a predetermined threshold, where adjusting the second parameter of the generative model is based at least in part on a loss function. In addition, the second parameter of the generative model may be adjusted in response to the noise level being within the predetermined threshold, where adjusting the second parameter of the generative model is based at least in part on a respective training score (e.g., training score 214).

### III. COMPUTER SYSTEM

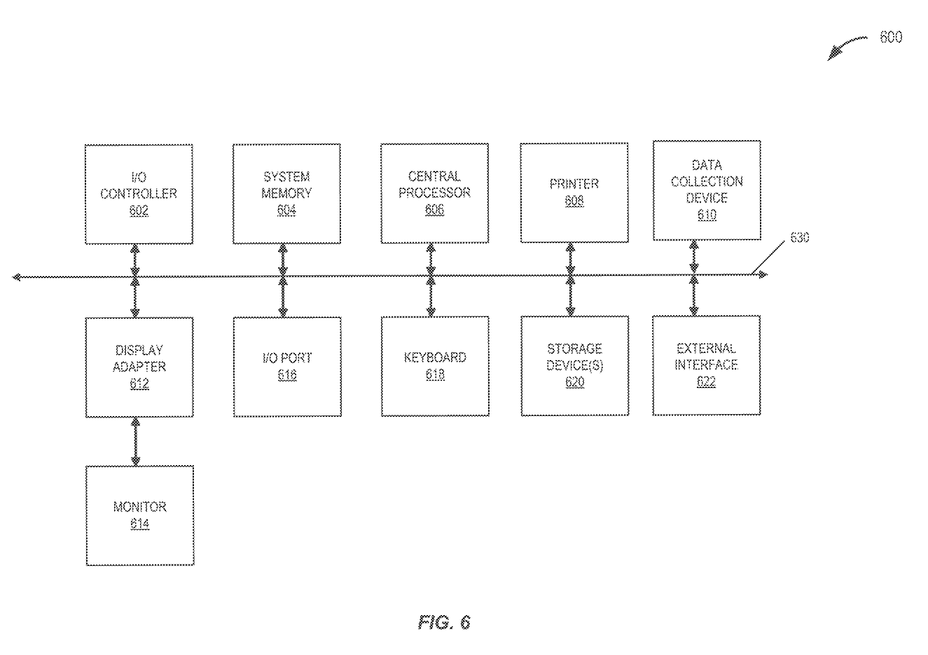

Any of the computer systems mentioned herein may utilize any suitable number of subsystems. Examples of such subsystems are shown in FIG. 6 in computer system 600. In some embodiments, a computer system includes a single computer apparatus, where the subsystems can be the components of the computer apparatus. In other embodiments, a computer system can include multiple computer apparatuses, each being a subsystem, with internal components. A computer system can include desktop and laptop computers, tablets, mobile phones and other mobile devices.

The subsystems shown in FIG. 6 are interconnected via a system bus 630. Additional subsystems such as a printer 608, keyboard 618, storage device(s) 620, monitor 614 (e.g., a display screen, such as an LED), which is coupled to display adapter 612, and others are shown. Peripherals and input/output (I/O) devices, which couple to I/O controller 602, can be connected to the computer system by any number of means known in the art such as input/output (I/O) port 616 (e.g., USB, FireWire^{®}). For example, I/O port 616 or external interface 622 (e.g., Ethernet, Wi-Fi, etc.) can be used to connect computer system 600 to a wide area network such as the Internet, a mouse input device, or a scanner. The interconnection via system bus 630 allows the central processor 606 to communicate with each subsystem and to control the execution of a plurality of instructions from system memory 604 or the storage device(s) 620 (e.g., a fixed disk, such as a hard drive, or optical disk), as well as the exchange of information between subsystems. The system memory 604 and/or the storage device(s) 620 may embody a computer readable medium. Another subsystem is a data collection device 610, such as a camera, microphone, accelerometer, and the like. Any of the data mentioned herein can be output from one component to another component and can be output to the user.

A computer system can include a plurality of the same components or subsystems, e.g., connected together by external interface 622, by an internal interface, or via removable storage devices that can be connected and removed from one component to another component. In some embodiments, computer systems, subsystem, or apparatuses can communicate over a network. In such instances, one computer can be considered a client and another computer a server, where each can be part of a same computer system. A client and a server can each include multiple systems, subsystems, or components. In various embodiments, methods may involve various numbers of clients and/or servers, including at least 10, 20, 50, 100, 200, 500, 1,000, or 10,000 devices. Methods can include various numbers of communication messages between devices, including at least 100, 200, 500, 1,000, 10,000, 50,000, 100,000, 500,00, or one million communication messages. Such communications can involve at least 1 MB, 10 MB, 100 MB, 1 GB, 10 GB, or 100 GB of data.

A summary of the various embodiments of the invention is provided below as a list of examples. As used below, any reference to a series of examples is to be understood as a reference to each of those examples disjunctively (e.g., "Examples 1-4" is to be understood as "Examples 1, 2, 3, or 4").

Example 1 is a method comprising: obtaining ground truth training data including first content, wherein the ground truth training data includes a first latent space representation of the first content; generating noisy training data by adding noise to the ground truth training data; generating, based at least in part on inputting the noisy training data to a generative model, de-noised training data; generating, based at least in part on inputting the de-noised training data to a discriminator model, a first score; adjusting a parameter of the discriminator model based at least in part on the first score; and adjusting a second parameter of the generative model based at least in part on the first score.

Example 2 is the method of example 1, further comprising: generating second de-noised training data based at least in part on the first score such that the second de-noised training data optimizes a second score determined by the discriminator model; adjusting the parameter of the discriminator model based at least in part on the second score; and adjusting the second parameter of the generative model based at least in part on the second score.

Example 3 is the method of example 2, wherein the first score or the second score are based at least in part on combining: a similarity score representing a degree of similarity between (i) the de-noised training data or (ii) the second de-noised training data and the ground truth training data; and a semantic score representing semantic alignment of the ground truth training data.

Example 4 is the method of example 3, wherein the similarity score is generated by the discriminator model determining a difference between a first value assigned to the de-noised training data and a second value assigned to the ground truth training data.

Example 5 is the method of example 3, wherein the semantic score is generated by the discriminator model comparing a first pairing of the ground truth training data with the training prompt and a second pairing of the ground truth training data with an unassociated prompt.

Example 6 is the method of example 1, further comprising: obtaining a prompt and an initial data sample; and generating, based at least in part on inputting the prompt and the initial data sample to the generative model comprising the adjusted second parameter, inference data.

Example 7 is the method of example 6, wherein the training prompt or the prompt comprise natural language text.

Example 8 is the method of example 1, wherein the ground truth training data comprises audio data.

Example 9 is the method of example 1, further comprising determining a noise level associated with the noisy training data, and wherein adjusting the second parameter of the generative model further comprises: in response to the noise level exceeding a predetermined threshold, adjusting the second parameter of the generative model based at least in part on a loss function; and in response to the noise level being within the predetermined threshold, adjusting the second parameter of the generative model based at least in part on a respective training score.

Example 10 is the method of example 1, wherein adjusting the parameter of the discriminator model and adjusting the second parameter of the generative model further comprises: adjusting the parameter of the discriminator model with a first objective to maximize a difference between a first metric assigned to the ground truth training data and a second metric assigned to a subsequent de-noised training data; and adjusting the second parameter of the generative model with a second objective to minimize the difference between the first metric assigned to the ground truth training data and the second metric assigned to the subsequent de-noised training data.

Example 11 is the method of example 1, wherein the de-noised training data is a continuous latent representation defined by a sequence of floating-point values.

Example 12 is the method of example 1, wherein at least one of the generative model or the discriminator model is initialized from a pretrained rectified model.

Example 13 is a system comprising: one or more storage media storing instructions; and one or more processors configured to execute the instructions to cause the system to: obtain ground truth training data including first content, wherein the ground truth training data includes a first latent space representation of the first content; generate noisy training data by adding noise to the ground truth training data; generate, based at least in part on inputting the noisy training data to a generative model, de-noised training data; generate, based at least in part on inputting the de-noised training data to a discriminator model, a first score; adjust a parameter of the discriminator model based at least in part on the first score; and adjust a second parameter of the generative model based at least in part on the first score.

Example 14 is the system of example 13, wherein the execution of the instructions further causes the system to: generate second de-noised training data based at least in part on the first score such that the second de-noised training data optimizes a second score determined by the discriminator model; adjust the parameter of the discriminator model based at least in part on the second score; and adjust the second parameter of the generative model based at least in part on the second score.

Example 15 is the system of example 14, wherein the first score or the second score are based at least in part on combining: a similarity score representing a degree of similarity between (i) the de-noised training data or (ii) the second de-noised training data and the ground truth training data; and a semantic score representing semantic alignment of the ground truth training data.

Example 16 is the system of example 15, wherein the similarity score is generated by the discriminator model determining a difference between a first value assigned to the de-noised training data and a second value assigned to the ground truth training data.

Example 17 is the system of example 15, wherein the semantic score is generated by the discriminator model comparing a first pairing of the ground truth training data with the training prompt and a second pairing of the ground truth training data with an unassociated prompt.

Example 18 is the system of example 13, wherein the execution of the instructions further causes the system to: obtain a prompt and an initial data sample; and generate, based at least in part on inputting the prompt and the initial data sample to the generative model comprising the adjusted second parameter, inference data.

Example 19 is the system of example 18, wherein the training prompt or the prompt comprise natural language text.

Example 20 is the system of example 13, wherein the ground truth training data comprises audio data.

Example 21 is the system of example 13, wherein the execution of the instructions further causes the system to determine a noise level associated with the noisy training data, and wherein the instructions to adjust the second parameter of the generative model comprise instructions to: in response to the noise level exceeding a predetermined threshold, adjust the second parameter of the generative model based at least in part on a loss function; and in response to the noise level being within the predetermined threshold, adjust the second parameter of the generative model based at least in part on a respective training score.

Example 22 is the system of example 13, wherein the instructions to adjust the parameter of the discriminator model and to adjust the second parameter of the generative model comprise instructions to: adjust the parameter of the discriminator model with a first objective to maximize a difference between a first metric assigned to the ground truth training data and a second metric assigned to a subsequent de-noised training data; and adjust the second parameter of the generative model with a second objective to minimize the difference between the first metric assigned to the ground truth training data and the second metric assigned to the subsequent de-noised training data.

Example 23 is the system of example 13, wherein the de-noised training data is a continuous latent representation defined by a sequence of floating-point values.

Example 24 is the system of example 13, wherein at least one of the generative model or the discriminator model is initialized from a pretrained rectified model.

Example 25 is one or more non-transitory computer-readable storage media storing instructions that, upon execution by one or more processors of a system, cause the system to perform operations comprising: obtaining ground truth training data including first content, wherein the ground truth training data includes a first latent space representation of the first content; generating noisy training data by adding noise to the ground truth training data; generating, based at least in part on inputting the noisy training data to a generative model, de-noised training data; generating, based at least in part on inputting the de-noised training data to a discriminator model, a first score; adjusting a parameter of the discriminator model based at least in part on the first score; and adjusting a second parameter of the generative model based at least in part on the first score.

Example 26 is the non-transitory computer-readable storage media of example 25, further comprising: generating second de-noised training data based at least in part on the first score such that the second de-noised training data optimizes a second score determined by the discriminator model; adjusting the parameter of the discriminator model based at least in part on the second score; and adjusting the second parameter of the generative model based at least in part on the second score.

Example 27 is the non-transitory computer-readable storage media of example 26, wherein the first score or the second score are based at least in part on combining: a similarity score representing a degree of similarity between (i) the de-noised training data or (ii) the second de-noised training data and the ground truth training data; and a semantic score representing semantic alignment of the ground truth training data.

Example 28 is the non-transitory computer-readable storage media of example 27, wherein the similarity score is generated by the discriminator model determining a difference between a first value assigned to the de-noised training data and a second value assigned to the ground truth training data.

Example 29 is the non-transitory computer-readable storage media of example 27, wherein the semantic score is generated by the discriminator model comparing a first pairing of the ground truth training data with the training prompt and a second pairing of the ground truth training data with an unassociated prompt.

Example 30 is the non-transitory computer-readable storage media of example 25, further comprising: obtaining a prompt and an initial data sample; and generating, based at least in part on inputting the prompt and the initial data sample to the generative model comprising the adjusted second parameter, inference data.

Example 31 is the non-transitory computer-readable storage media of example 30, wherein the training prompt or the prompt comprise natural language text.

Example 32 is the non-transitory computer-readable storage media of example 25, wherein the ground truth training data comprises audio data.

Example 33 is the non-transitory computer-readable storage media of example 25, further comprising determining a noise level associated with the noisy training data, and wherein adjusting the second parameter of the generative model further comprises: in response to the noise level exceeding a predetermined threshold, adjusting the second parameter of the generative model based at least in part on a loss function; and in response to the noise level being within the predetermined threshold, adjusting the second parameter of the generative model based at least in part on a respective training score.

Example 34 is the non-transitory computer-readable storage media of example 25, wherein adjusting the parameter of the discriminator model and adjusting the second parameter of the generative model further comprises: adjusting the parameter of the discriminator model with a first objective to maximize a difference between a first metric assigned to the ground truth training data and a second metric assigned to a subsequent de-noised training data; and adjusting the second parameter of the generative model with a second objective to minimize the difference between the first metric assigned to the ground truth training data and the second metric assigned to the subsequent de-noised training data.

Example 35 is the non-transitory computer-readable storage media of example 25, wherein the de-noised training data is a continuous latent representation defined by a sequence of floating-point values.

Example 36 is the non-transitory computer-readable storage media of example 25, wherein at least one of the generative model or the discriminator model is initialized from a pretrained rectified model.

Aspects of embodiments can be implemented in the form of control logic using hardware circuitry (e.g., an application specific integrated circuit or field programmable gate array) and/or using computer software stored in a memory with a generally programmable processor in a modular or integrated manner, and thus a processor can include memory storing software instructions that configure hardware circuitry, as well as an FPGA with configuration instructions or an ASIC. As used herein, a processor can include a single-core processor, multi-core processor on a same integrated chip, or multiple processing units on a single circuit board or networked, as well as dedicated hardware. The computations can be performed in parallel by the different processing units and/or different processing threads of a single processing unit. Based on the disclosure and teachings provided herein, a person of ordinary skill in the art will know and appreciate other ways and/or methods to implement embodiments of the present disclosure using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such devices. In addition, the order of operations may be re-arranged. A process can be terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Such programs may also be encoded and transmitted using carrier signals adapted for transmission via wired, optical, and/or wireless networks conforming to a variety of protocols, including the Internet. As such, a computer readable medium according to an embodiment of the disclosed techniques may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Any operations performed with a processor may be performed in real-time. The term “real-time” may refer to computing operations or processes that are completed within a certain time constraint. As examples, a time constraint may be 30 seconds, 1 minute, 10 minutes, 30 minutes, 1 hour, 4 hours, 1 day, or 7 days. Thus, embodiments can be directed to computer systems configured to perform the steps of any of the methods described herein, potentially with different components performing a respective step or a respective group of steps. Although presented as numbered steps, steps of methods herein can be performed at a same time or at different times or in a different order. Additionally, portions of these steps may be used with portions of other steps from other methods. Also, all or portions of a step may be optional. Additionally, any of the steps of any of the methods can be performed with modules, units, circuits, or other means of a system for performing these steps.

The above description is illustrative and is not restrictive. Many variations of the disclosed will become apparent to those skilled in the art upon review of the disclosure. The scope of the disclosed should, therefore, be determined not with reference to the above description, but instead should be determined with reference to the pending claims along with their full scope or equivalents.

One or more features from any embodiment may be combined with one or more features of any other embodiment without departing from the scope of the disclosed.

A recitation of "a," "an" or "the" is intended to mean "one or more" unless specifically indicated to the contrary. The use of “or” is intended to mean an “inclusive or,” and not an “exclusive or” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

All patents, patent applications, publications, and descriptions mentioned herein are incorporated by reference in their entirety for all purposes. None is admitted as prior art. Where a conflict exists between the instant application and a reference provided herein, the instant application shall dominate.

What is claimed is:

1. A system comprising:
one or more storage media storing instructions; and
one or more processors configured to execute the instructions to cause the system to:
obtain ground truth training data including first content, wherein the ground truth training data includes a first latent space representation of the first content;
generate noisy training data by adding noise to the ground truth training data;
generate, based at least in part on inputting the noisy training data to a generative model, de-noised training data;
generate, based at least in part on inputting the de-noised training data to a discriminator model, a first score;
adjust a parameter of the discriminator model based at least in part on the first score; and
adjust a second parameter of the generative model based at least in part on the first score.

2. The system of claim 1, wherein the execution of the instructions further causes the system to:
generate second de-noised training data based at least in part on the first score such that the second de-noised training data optimizes a second score determined by the discriminator model;
adjust the parameter of the discriminator model based at least in part on the second score; and
adjust the second parameter of the generative model based at least in part on the second score.

3. The system of claim 2, wherein the first score or the second score are based at least in part on combining:
a similarity score representing a degree of similarity between (i) the de-noised training data or (ii) the second de-noised training data and the ground truth training data; and
a semantic score representing semantic alignment of the ground truth training data.

4. The system of claim 3, wherein the similarity score is generated by the discriminator model determining a difference between a first value assigned to the de-noised training data and a second value assigned to the ground truth training data.

5. The system of claim 3, wherein the semantic score is generated by the discriminator model comparing a first pairing of the ground truth training data with the training prompt and a second pairing of the ground truth training data with an unassociated prompt.

6. The system of claim 1, wherein the execution of the instructions further causes the system to:
obtain a prompt and an initial data sample; and
generate, based at least in part on inputting the prompt and the initial data sample to the generative model comprising the adjusted second parameter, inference data.

7. The system of claim 6, wherein the training prompt or the prompt comprise natural language text.

8. The system of claim 1, wherein the ground truth training data comprises audio data.

9. The system of claim 1, wherein the execution of the instructions further causes the system to determine a noise level associated with the noisy training data, and wherein the instructions to adjust the second parameter of the generative model comprise instructions to:
in response to the noise level exceeding a predetermined threshold, adjust the second parameter of the generative model based at least in part on a loss function; and
in response to the noise level being within the predetermined threshold, adjust the second parameter of the generative model based at least in part on a respective training score.

10. The system of claim 1, wherein the instructions to adjust the parameter of the discriminator model and to adjust the second parameter of the generative model comprise instructions to:
adjust the parameter of the discriminator model with a first objective to maximize a difference between a first metric assigned to the ground truth training data and a second metric assigned to a subsequent de-noised training data; and
adjust the second parameter of the generative model with a second objective to minimize the difference between the first metric assigned to the ground truth training data and the second metric assigned to the subsequent de-noised training data.

11. The system of claim 1, wherein the de-noised training data includes a continuous latent representation defined by a sequence of floating-point values.

12. The system of claim 1, wherein at least one of the generative model or the discriminator model is initialized from a pretrained rectified model.

13. A method comprising:
obtaining ground truth training data including first content, wherein the ground truth training data includes a first latent space representation of the first content;
generating noisy training data by adding noise to the ground truth training data;
generating, based at least in part on inputting the noisy training data to a generative model, de-noised training data;
generating, based at least in part on inputting the de-noised training data to a discriminator model, a first score;
adjusting a parameter of the discriminator model based at least in part on the first score; and
adjusting a second parameter of the generative model based at least in part on the first score.

14. The method of claim 13 further comprising:
generating second de-noised training data based at least in part on the first score such that the second de-noised training data optimizes a second score determined by the discriminator model;
adjusting the parameter of the discriminator model based at least in part on the second score; and
adjusting the second parameter of the generative model based at least in part on the second score.

15. The method of claim 14, wherein the first score or the second score are based at least in part on combining:
a similarity score representing a degree of similarity between (i) the de-noised training data or (ii) the second de-noised training data and the ground truth training data; and
a semantic score representing semantic alignment of the ground truth training data.

16. The method of claim 13 further comprising:
obtaining a prompt and an initial data sample; and
generating, based at least in part on inputting the prompt and the initial data sample to the generative model comprising the adjusted second parameter, inference data.

17. One or more non-transitory computer-readable storage media storing instructions that, upon execution by one or more processors of a system, cause the system to perform operations comprising:
obtaining ground truth training data including first content, wherein the ground truth training data includes a first latent space representation of the first content;
generating noisy training data by adding noise to the ground truth training data;
generating, based at least in part on inputting the noisy training data to a generative model, de-noised training data;
generating, based at least in part on inputting the de-noised training data to a discriminator model, a first score;
adjusting a parameter of the discriminator model based at least in part on the first score; and
adjusting a second parameter of the generative model based at least in part on the first score.

18. The one or more non-transitory computer-readable storage media of claim 17, wherein the operations further comprise:
generating second de-noised training data based at least in part on the first score such that the second de-noised training data optimizes a second score determined by the discriminator model;
adjusting the parameter of the discriminator model based at least in part on the second score; and
adjusting the second parameter of the generative model based at least in part on the second score.

19. The one or more non-transitory computer-readable storage media of claim 18, wherein the first score or the second score are based at least in part on combining:
wherein the first score or the second score are based at least in part on combining:
a similarity score representing a degree of similarity between (i) the de-noised training data or (ii) the second de-noised training data and the ground truth training data; and
a semantic score representing semantic alignment of the ground truth training data.

20. The one or more non-transitory computer-readable storage media of claim 17, wherein the operations further comprise:
obtaining a prompt and an initial data sample; and
generating, based at least in part on inputting the prompt and the initial data sample to the generative model comprising the adjusted second parameter, inference data.
